(19) United States
(12) Patent Application Publication
(10) Pub. No.: US 2010/0165839 A1
(43) Pub. Date: Jul. 1, 2010

(54) ANTI-REPLAY METHOD FOR UNICAST AND MULTICAST IPSEC

(75) Inventors: THOMAS J. SENESE, Schaumburg, IL (US); MICHAEL W. BRIGHT, Arlington Heights, IL (US); DIPENDRA M. CHOWDHARY, Hoffman Estates, IL (US); CHRIS A. KRUEGEL, Plainfield, IL (US); LARRY MURRILL, Schaumburg, IL (US); TIMOTHY G. WOODWARD, Tempe, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/345,160

(22) Filed: Dec. 29, 2008

(51) Int. Cl. H04L 12/26

(52) U.S. Cl. 370/232

(57) ABSTRACT

A method for managing a packet in a communication system between two or more endpoints, a sender and one or more recipients, comprises receiving a first packet comprising a source identifier that uniquely identifies a sender of the first packet and a current source time assigned to the first packet by the sender, determining a received time for the first packet, retrieving a cached source time assigned by the sender to a second packet that was received prior to receiving the first packet, and determining whether to discard or process the first packet based on the current source time, the received time, and the cached source time. The current source time, the received time, and the cached time, in addition to predetermined parameters such as a maximum age and an anti-replay window allows a recipient to determine whether to process or discard a packet.

### TECHNICAL FIELD

This technical field relates generally to communication systems, and in particular, it relates to a method of transmitting packets securely over an untrusted network and preventing replay of duplicate transmission packets.

### BACKGROUND

Communications have advanced significantly over the past several years. Digital communication over a wide variety of networks provides for faster and more up-to-date information to be communicated over greater distances than ever before. As the number of communications increase and as the number of different networks between the recipient and the sender increase, the possibility that the communication may be intercepted and otherwise contaminated increases as well. Therefore, the need to send data securely over various networks without fear of corruption of the data is very important. In particular, it is important for the receiving communication device to be able to determine if a packet has been corrupted by determining if it has already received a packet, if a packet has been sent out of order, or if a packet is old and no longer necessary. In other words, it is important for the recipient to have anti-replay capability.

Internet protocol security (“IPsec”) provides secure gateway-to-gateway connections at the internet protocol (IP) layer across private wide area network (WAN) or Internet-based connections. IPsec is a suite of protocols for securing IP communications by authenticating and encrypting each packet or datagram of a communication or data stream. A packet or datagram is a portion of a digital communication or data stream transmitted over a communication network, such as a packet-switching network found in narrowband and broadband communication systems. IPsec can be used to protect data flows between a pair of hosts (e.g. computer users or servers or radios), between a pair of security gateways (e.g. routers or firewalls), or between a security gateway and a host.

Currently, IPsec data security uses a sequence number found in an IPsec packet header to determine if a packet received by a recipient, such as a radio or computer, is a duplicate of a packet previously received by the recipient.

A packet header is part of the data packet and contains transparent information about the file or the transmission. Currently, an initial sequence number is derived during an internet key exchange (IKE) set-up for a new virtual private network (VPN) session between two endpoints. The IKE establishes dual security associations between the two endpoints. A security association is a simplex connection that affords security services to the packets carried by it. Each time one VPN source sends a new packet through the VPN session, the sequence number is incremented by one. The VPN recipient rejects any received IPsec packet if the sequence number is less than or equal to that of the last received IPsec packet from the source over the same VPN session.

IKE is conducted between two specific endpoints. Unfortunately, it is not practical to use IKE for multicast security associations. As a result, the IPsec sequence number is not used for replay protection for multicast traffic.

On narrowband channels, such as the Project 25 air interface, the use of IKE between a large population of radios and the infrastructure, such as a network server, will create significant performance degradation in many situations. Therefore, IKE cannot be realistically used on high density channels. In the absence of IKE, however, it is not possible to use the IPsec sequence number for replay protection. Therefore, a different method to apply replay protection over a VPN is needed.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1 is a diagram of a network utilizing an embodiment of the present disclosure;

FIG. 2 illustrates two embodiments of transmitting a data packet over an untrusted network;

FIG. 3 is an illustration of a packet in accordance with the principles of the present disclosure;

FIG. 4 is a flow chart of another embodiment of the method of the present disclosure; and

FIG. 5 is a flowchart of another embodiment of the method of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

A method for managing a packet in a communication system between endpoints, a sender and one or more recipients, comprises receiving a first packet comprising a source identifier that uniquely identifies a sender (also referred to herein as a source) of the first packet and a current source time assigned to the first packet by the sender, determining a received time for the first packet, retrieving a cached source time assigned by the sender to a second packet that was received prior to receiving the first packet, and determining whether to discard or process the first packet based on the current source time, the received time, and the cached source time. The method also includes discarding the first packet when a difference between the current source time and the received time of the first packet is greater than a maximum age. In addition, it may also include discarding the first packet when a difference between the current source time and the received time of the first packet is equal to a maximum age threshold or discarding the first packet when the current source time is the same as the cached source time.

The first packet is discarded when a difference between the cached source time and the current source time is greater than an anti-replay window value.

If the packet is not discarded, then the packet is processed when the difference between the cached source time and current source time is equal to the anti-replay window value. The packet is also processed when the current source time is greater (i.e. more recent) than the cached source time and the cached source time is replaced with the current source time.

The first packet is also processed when a difference between the cached source time and the current source time is less than an anti-replay time window value, but is discarded when a sum of the current source time and an anti-replay window value is less than the received time.

The first packet is also processed when a sum of the current source time and an anti-replay window value is greater or more recent than the received time or when a sum of the current source time and an anti-replay window value is equal to the received time.

The first packet comprises an internet protocol security encapsulating security payload (ESP) format and is capable of being received at a multicast address. The cached source time is discarded when it exceeds a maximum age threshold. While the ESP format is used herein as an illustrative embodiment of the present disclosure, it is not intended to limit the present disclosure. A variety of payload formats may be used including authentication only (AH, authentication header) payload format. In addition, any format that includes an area for packet identifying information and timestamp information is within the scope of the present disclosure.

As used herein, a source identifier enables identification of different packets of the communication. The source identifier includes a source identity (source ID) and a security parameter index (SPI) pair. The SPI is a unique identifier of a security association, and is included in the IPsec header. The combination of the source ID and SPI uniquely identifies the sender of the packet.

A current source time is the time stamp assigned by the sender, which can be included in the sequence number field of the IPsec header in one embodiment. A received time is the time indicated by the recipient's internal clock upon receiving a new IPsec packet.

A cached source time is the time stamp associated with the source time of the last received packet for a source identifier and is stored in a cache. The cached source time is included in the cache as long as the age of the entry does not exceed a maximum age. Source times from received IPsec packets are cached, along with the SPI and source ID of the sender, for a period of time that does not exceed the maximum age. The cached source times are used in order to determine whether a time misalignment between the sender and recipient is due to a disorder of received packets, clocking differences or replay.

A maximum age is a pre-configured parameter that defines the maximum age allowed for a received packet. If the difference between the received time and the current source time is greater than the maximum age, the recipient will discard the packet. An anti-replay window is a pre-configured parameter that defines the window of time where out-of-order packets are accepted. This anti-replay window also accounts for differences in clock rates of the sender and recipient. It is understood that a difference between times may be positive or negative and that an absolute value of the time difference is herein disclosed.

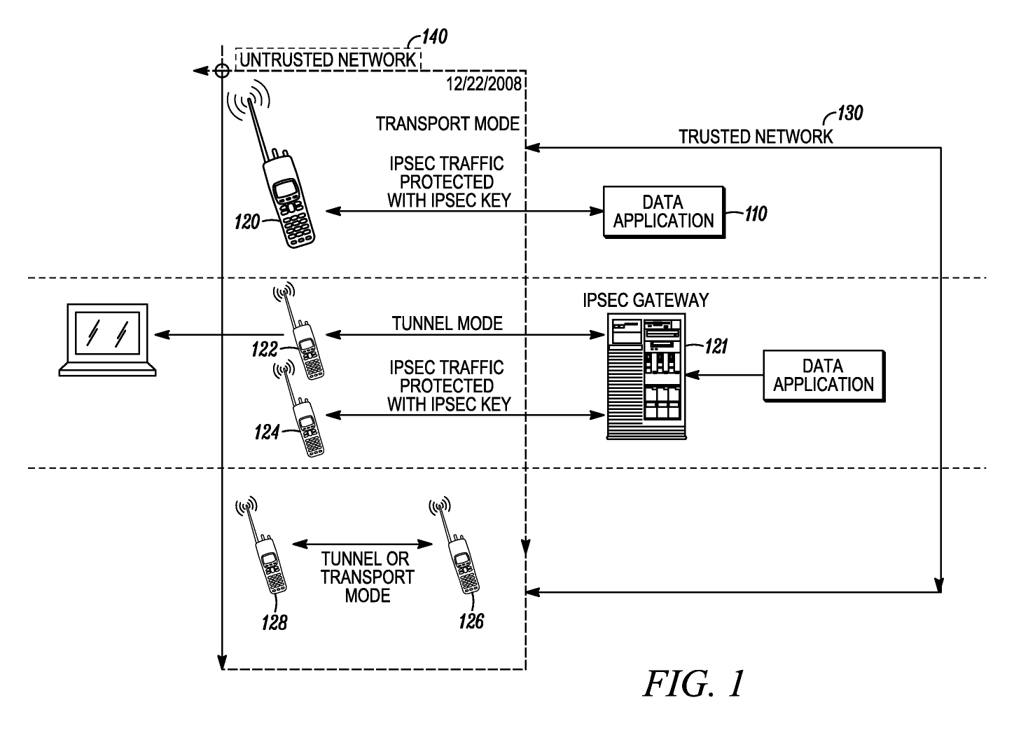

Referring now to the figures, and in particular FIG. 1, there is shown an illustrative diagram of a system in accordance with the principles of the present disclosure. Packets are sent in a communication over trusted and untrusted networks in the present examples. In a first example, a packet is sent directly from a sender 110, in this example a data application, to a recipient 120, in this case a radio. The sender 110 is in a trusted network 130; however, the packet travels over untrusted networks to get to the recipient 120. Thus, in this example, the packet is authenticated and/or encrypted, and includes anti-replay protection, for security. In this first example, the packet travels to the recipient 120, in transport mode. In a second example however, a packet is multicast from a different sender 121, an IPsec gateway, to recipients 122, 124 in tunnel mode. A third example is shown wherein two endpoints 126, 128 send packets to one another over entirely untrusted networks in either tunnel or transport mode.

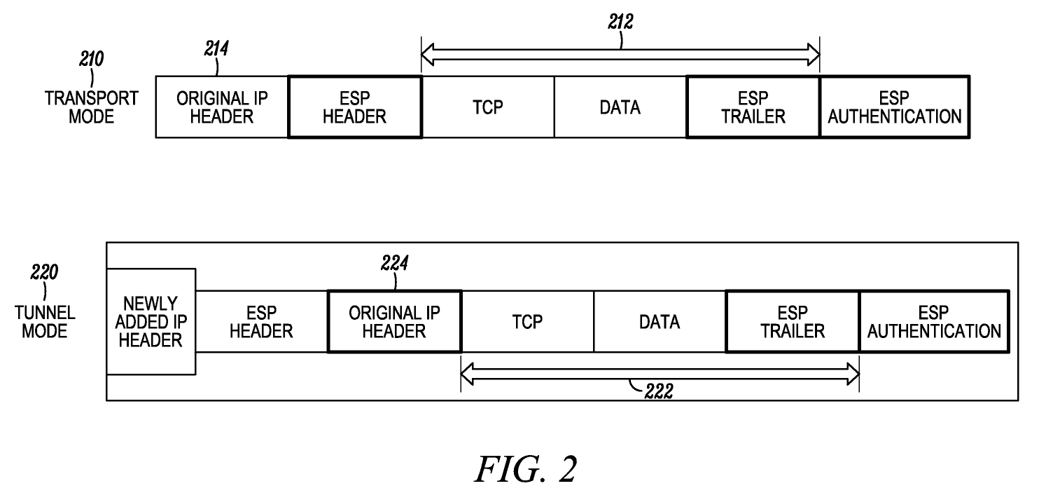

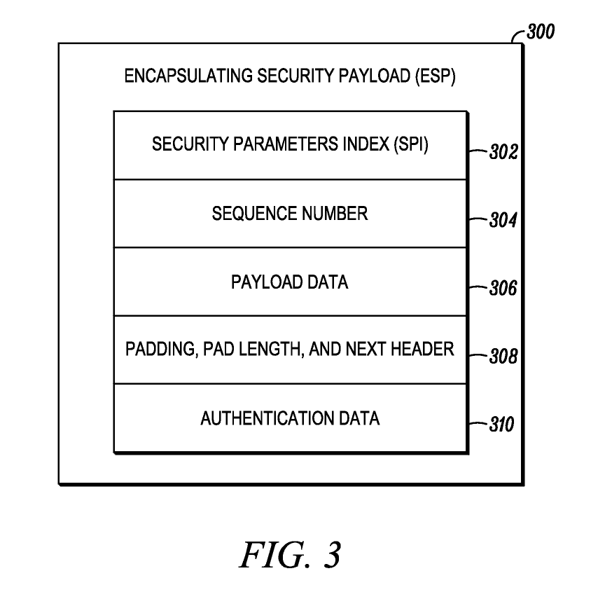

Turning now to FIGS. 2 and 3, as referred to above, IPsec supports two encryption modes: transport and tunnel. It is understood that many versions or embodiments of IPsec exist, and the present disclosure includes all versions or embodiments of IPsec, including but not limited to, IPv4 and IPv6. Transport mode 210 inserts an ESP header after the IP header, but before a next layer protocol, such as TCP and UDP. Transport mode encrypts only a data 212 portion (payload) of each packet, but leaves an original header 214 untouched. In tunnel mode 220, the ultimate source and destination/recipient addresses are included in an inner-layer IP header, while an outer-layer IP header includes the source and destination addresses of the peer IPsec end points. The ESP header is inserted between the two IP headers. Tunnel mode encrypts both a header 224 and a data 222 payload.

Transport mode 210 is generally used when the source and destination for IP communications are also the IPSec endpoints. Tunnel mode 220 is used when the ultimate source and destination for IP communications pass through gateways that act as peer IPsec endpoints for VPNs. Tunnel mode 220 is used to create VPNs for network-to-network communications (e.g. between routers to link sites), host-to-network communications (e.g. remote user access), and host-to-host communications (e.g. private chat). On the receiving side, an IPSec-compliant device, such as radios 120, 124, 126, and 128, decrypts each packet and optionally authenticates the packet.

Turning to FIG. 3, an example of a packet 300 is shown. The packet 300 includes various fields such as the SPI 302, a sequence number 304, a payload data 306, a padding 308, and authentication data 3 10. In one embodiment, a current source time is used in place of a sequence number 304 for replay protection. In another embodiment, the current source time can be placed in another part of the packet, such as pre-pending or appending it to the payload data. In a present embodiment, the sender of an IPsec packet inserts a source time stamp into the 64-bit Sequence Number field 304 in the IPsec header 300. As an example, the time stamp can be partitioned as follows: Microseconds—20 bits, Seconds—12 bits, Hour—4 bits, Day—5 bits, Month—4 bits, Year—11 bits, and Unused—4 bits.

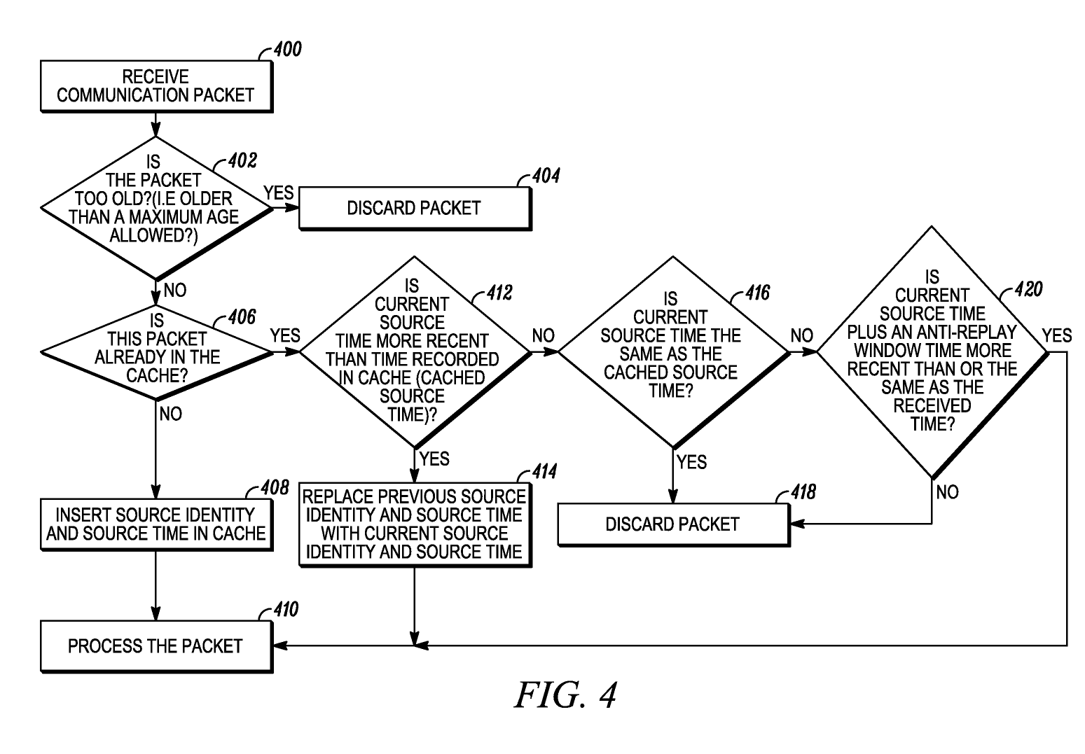

The recipient uses method to verify that the received packet has not been replayed. Turning now to FIG. 4, a flowchart of a method for determining if a packet has already been received is shown. In order to support this method, the recipient is configured with the following parameters: a maximum age, an anti-replay window of time, and a cache for storing source identities and a cached source time for a packet.

In FIG. 4 a communication packet is received, block 400. The recipient of the packet determines if the packet is older than the maximum age allowed, block 402. It is understood that the age of the packet may be calculated having positive and negative values, depending on differences in sender and recipient clocks or other factors; thus, the age of a packet is discussed herein in terms of its absolute value. If it is, the packet is discarded, block 404. If the packet does not exceed the maximum age allowed for the packet, as configured in the recipient, the recipient then determines if the packet, or the packet's source identifier and an accompanying cached source time is already stored in the cache, block 406. If it is not already in the cache, the recipient inserts the packet's source identifier and source time in the cache, block 408 and then processes the packet, block 410.

If however, the packet's source identifier and source time are already in the cache, the recipient determines if the current source time of the received packet is more recent in time than the cached source time (i.e., the one recorded in the cache), block 412. If it is, then the entry in the cache is replaced or updated with the source identifier and current source time, block 414, and the packet is processed, block 410.

If however, the recipient determines that the current source time of the received packet is not more recent in time than the one recorded in the cache (cached source time), then the recipient determines when the packet was sent. If the current source time is the same as the cached source time, block 416, the packet is discarded, block 418, because the same packet has been received twice.

If the current source time plus a predefined window of time, such as an anti-replay window, is more recent than a received time of the packet (i.e., the time indicated by the recipient's internal clock upon receiving a new IPsec packet), block 420, then the packet is processed, block 410. If it is the same as or not more recent than the received time, it is discarded, block 418. In other words, if the packet is calculated to have arrived at the recipient's device within a predefined window of time after being sent, it is processed, since the packet is a packet that has been received out of order.

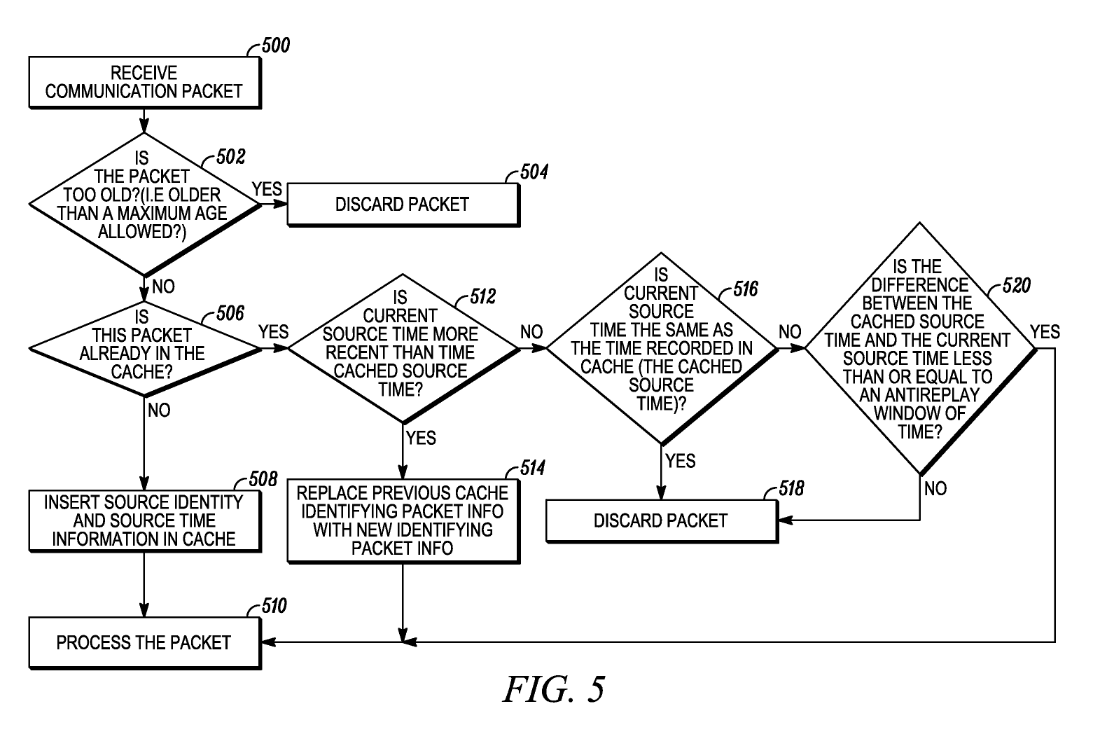

In another embodiment, as shown in FIG. 5, a communication packet is received, block 500. The recipient of the packet determines if the packet is older than the absolute value of the maximum age allowed, block 502. If it is, the packet is discarded, block 504. If the packet does not exceed the maximum age allowed for the packet, as configured in the recipient, the recipient then determines if the packet, or the packet's source identifier and accompanying current source time is already stored in the cache, block 506. If it is not already in the cache, the recipient inserts the packet's source identifier and current source time in the cache, block 508 and then processes the packet, block 5 10.

If however, the packet's source identifier and current source time are already in the cache, the recipient determines if the current source time of the received packet is more recent in time than the one recorded in the cache (cached source time), block 512. If it is, then the entry in the cache is replaced or updated with the source identifier and new source time, block 514, and the packet is processed, block 510.

If however, the recipient determines that the current source time of the received packet is not more recent in time than the one recorded in the cache, then the recipient determines when it was sent. If the received packet's current source time is the same as the cached source time, block 516, the packet is discarded, block 518, because the same packet has been received twice.

In contrast to the previous embodiment, however, if the source time is not the same as cached source time, nor is it more recent than the cache source time, then the recipient determines if the difference between the cached source time and the current source time is less than or equal to a predefined window of time, such as an antireplay window, block 520. If it is, then the packet is processed, block 510, since the packet was received out of order. If it is not, the packet is discarded, block 518.

FIGS. 4 and 5 illustrate different types of replay attacks and different methods of combating the same. In other words, FIG. 5 illustrates an example of a replay type attack when the same packet, not older than the maximum age, but older than the cached packet from the same source identifier, is continuously received. The recipient will process every instance of receiving the packet for up to an interval that is equal to the anti-replay window. Thus, choosing a smaller anti-replay window minimizes the vulnerability of the recipient to this type of replay attack. In the method shown in FIG. 4, however, the recipient will process the repeated packet for up to an interval that is equal to the allowed maximum packet age; this interval should be significantly larger than the anti-replay window.

The anti-replay window is a perceived interval where packets may be spatially misordered, and still be accepted. It is understood that some network anomalies may result in the misordered reception of packets. For example, if the packets of a data stream occasionally take different paths to the reach the destination, and the transit times of the paths are different, then there may arise situations where the recipient sees a new packet arrive before an older packet. The anti-replay window is configured according to the network user's policy. A smaller window value provides better security by minimizing the time in which spatially misordered packets will be accepted. A too small window size, however, may degrade network performance by preventing the successful qualification of spatially misordered packets under some exception conditions. Therefore, the size of the anti-replay window depends on a balance of desired security and network flexibility.

In conclusion, the benefits of the present disclosure are numerous. A recipient is able to differentiate between old packets and new packets, between trusted packets and those which have been compromised in a multicast environment without having to rely on IKE or other unicast type security methods. Those skilled in the art will realize that the above recognized advantages and other advantages described herein are merely illustrative and are not meant to be a complete rendering of all of the advantages of the various embodiments.

As used herein, an infrastructure device is a device that is a part of a fixed network infrastructure and can receive information (either control or media, e.g., data, voice (audio), video, etc.) in a signal from a wireless communication device and transmit information in signals to one or more wireless communication devices via a communication link. The infrastructure includes, but is not limited to, equipment commonly referred to as servers, controllers, base stations, base transceiver stations, access points, routers, or any other type of infrastructure equipment interfacing a wireless communication device or subscriber unit in a wireless environment.

A narrowband communication device includes, but is not limited to, devices commonly referred to as access terminals, mobile radios, portable radios, mobile stations, wireless communications devices, user equipment, mobile devices, or any other narrowband communication device capable of operating in a wireless environment. Examples of digital narrowband communication systems include APCO P25 Phase I, APCO P25 Phase II, Dimetra, iDEN, and DMR. Examples of broadband communication devices include, but are not limited to, mobile phones, cellular phones, Personal Digital Assistants (PDAs), laptops, desktops, and any other device capable of receiving or accessing multimedia content from a broadband system. Digital broadband communication systems include, but are not limited to, IEEE standards for wireless networking such as 802.11 and 802.16, and other wireless technologies such as evolution data optimized (EVDO), universal mobile telecommunications service (UMTS), high speed packet access (HSPA), and long term evolution (LTE) wireless technologies.

In the foregoing specification, specific embodiments have been described. However, one of ordinary skill in the art will appreciate that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for indicating status of channels assigned to a talkgroup described herein. The non-processor circuits may include, but are not limited to, a radio receiver, a radio transmitter, signal drivers, clock circuits, power source circuits, and user input devices. As such, these functions may be interpreted as steps of a method to perform the indicating of status of channels assigned to a talkgroup described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for managing a packet in a communication system, the method comprising:
receiving a first packet comprising a source identifier that uniquely identifies a sender of the first packet and a current source time assigned to the first packet by the sender;
determining a received time for the first packet;
retrieving a cached source time assigned by the sender to a second packet that was received prior to receiving the first packet; and
determining whether to discard or process the first packet based on the current source time, the received time, and the cached source time.

2. The method of claim 1 further comprising:
discarding the first packet when a difference between the current source time and the received time of the first packet is greater than a maximum age.

3. The method of claim 1 further comprising:
discarding the first packet when a difference between the current source time and the received time of the first packet is equal to a maximum age.

4. The method of claim 1 further comprising:
discarding the first packet when the current source time is the same as the cached source time.

5. The method of claim 1 further comprising:
processing the first packet when the current source time is more recent than the cached source time.

6. The method of claim 5 further comprising:
replacing the cached source time with the current source time.

7. The method of claim 1 further comprising:
discarding the first packet when a difference between the cached source time and the current source time is greater than an anti-replay window value.

8. The method of claim 1 further comprising:
processing the packet when the difference between the cached source time and current source time is equal to an anti-replay window value.

9. The method of claim 1 further comprising:
processing the first packet when a difference between the cached source time and the current source time is less than an anti-replay window value.

10. The method of claim 1 further comprising:
discarding the first packet when a sum of the current source time and an anti-replay window value is less than the received time.

11. The method of claim 1 further comprising:
processing the first packet when a sum of the current source time and an anti-replay window value is greater than the received time.

12. The method of claim 1 further comprising:
processing the first packet when a sum of the current source time and an anti-replay window value is equal to the received time.

13. The method of claim 1, wherein the first packet comprises an internet protocol security encapsulating security payload format.

14. The method of claim 1, wherein the first packet comprises an internet protocol security authentication header payload format.

15. The method of claim 1 wherein the first packet is received at a multicast address.

16. The method of claim 1 further comprising discarding the cached source time when it exceeds a maximum age.
